(19) United States
(12) Patent Application Publication
(10) Pub. No.: US 2017/0026720 A1
(43) Pub. Date: Jan. 26, 2017

(54) SYSTEMS AND METHOD FOR PROVIDING MULTIMEDIA CONTENT IN A NETWORK

(71) Applicant: Hashplay Inc., San Francisco, CA (US)

(72) Inventor: Ingo Nadler, Bad Breisig (DE)

(21) Appl. No.: 15/168,392

(22) Filed: May 31, 2016

Related U.S. Application Data
(60) Provisional application No. 62/167,317, filed on May 28, 2015.
(60) Provisional application No. 62/169,605, filed on Jun. 2, 2015.
(60) Provisional application No. 62/190,804, filed on Jul. 10, 2015.

(51) Int. Cl. H04N 21/858; H04N 21/4725; H04N 21/61; H04N 21/44

(52) U.S. Cl. CPC H04N 21/8586; H04N 21/44008; H04N 21/4725; H04N 21/6125

(57) ABSTRACT

Disclosed are methods and systems for providing multimedia content in a network. The method includes receiving a multimedia stream including at least one pattern; assigning at least one hyperlink to each of time indexed bits of the multimedia stream including the at least one pattern; broadcasting the multimedia stream including the at least one hyperlink; receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and providing another multimedia stream corresponding to at least one of the at least one hyperlink and the broadcasting channel information to the computing device.

### TECHNICAL FIELD

The present disclosure relates generally to a method for providing multimedia content in a network; and more specifically, to a system for providing multimedia content in a network. The present disclosure further relates to systems and methods for associating additional information, such as hyperlinks, with multimedia content which is broadcasted. Further, the present disclosure relates to methods and systems for tagging the multimedia content with keywords and patterns. Furthermore, the present disclosure relates to methods and systems for assembly of user generated linear TV.

### BACKGROUND

In recent past, due to emergence of various internet connected devices, there has been a proliferation in consumption of multimedia content. The multimedia content can be for example, an audio stream, a video stream, or a combination thereof. Further, there has been a drastic change in how the multimedia content viewed by a viewer, for example on a smart phone, a computer, a laptop, a tablet computer, a television (TV), and so forth. Various TV broadcasting systems or channels or individual (hereinafter, collectively referred as TV broadcasters) broadcast multimedia content that can be viewed on a display device like TV, smart phone, etc. Linear television is very popular among viewers these days.

The linear television is a mix of a live content or a pre-recorded content, with a pre-determined broadcasting schedule decided by a broadcaster. For example, the viewer has to watch a particular content at a particular time the content is broadcasted and on a specific channel it is presented on. The television broadcasters broadcasting the linear TV may encode video and audio information coming from a file or live video stream with any known codec, such as H.264 or MPEG, and then transmit it via a network including a satellite, a cable network, or the Internet®. Further, the TV broadcasters may also create a detailed low level playlist or a broadcasting schedule of their TV programming. High level schedules are created via electronic programming guide (EPG) generators. An EPG being an electronic programming guide, containing the breakdown in individual broadcasts and contents.

Presently available techniques allow the broadcaster to send the multimedia content (or TV programming) in a particular format for example, hybrid broadcast broadband television or HbbTV that has to be understood by the viewing device, such as a television set. Such formats may not be compatible with old television sets. As the data remains on the TV set, and therefore, the present techniques do not provide the viewer, an experience of using a second screen (for example, a mobile phone). Further, such techniques do allow association of an additional web based information (for example, an advertised product information) with a current streaming content.

Further, nowadays, the multimedia content can be user generated, for example a user generated clip, which is broadcasted without a pre-determined broadcasting schedule. Currently, the user generated, content is either live without preset times or available on-demand viewing using websites or web applications. Usually, such content is delivered to a viewer via the multimedia content delivery network (CDN). The CDN may further serve as a temporary storage of the multimedia content (for on demand viewing). Viewers are usually served with an Electronic Programming guide (EP) as a guide to the timing of the multimedia content. The conventional techniques do not offer a freedom to include live events and create linear TV channels dynamically with user-generated content. Moreover, assembling a linear television broadcasting schedule from a pre-recorded or user-generated content is dull and often not very reliable.

Further, in a live video platform environment, when recorded live content is supposed to be put onto a platform for on-demand viewing, it is difficult to use the descriptive text for tagging of the multimedia content in a live video platform environment with keywords. Currently, as the descriptive text has to be written prior to a live broadcast and may lead to missing of important keywords or content parts that only occur during the broadcast due to its live nature. Typically, the descriptive text and title of the multimedia content is used for tagging and indexing.

Therefore, in light of the above-stated discussion, there exists a need for improved techniques associated with providing multimedia content, for example, broadcasting of the multimedia content.

### SUMMARY

These days, more users are using mobile devices, such as smart phones, smart watches, tablet computers, and so forth, for watching TV programming. Hence, it is desired to associate additional web based information such as, web address or Uniform Resource Locator along with a specific type of TV programming or multimedia content like a link to a TV show or music video, with current TV programming to easily retrieve for example, actor or advertising product information.

The present disclosure seeks to provide a method for providing multimedia content in a network.

The present disclosure further seeks to provide another method for providing multimedia content in a network.

The present disclosure furthermore seeks to provide a system for providing multimedia content in a network.

In a first aspect, an embodiment of the present disclosure provides a method for providing multimedia content in a network, the method comprising:

receiving a multimedia stream including at least one pattern;

assigning at least one hyperlink to each of time indexed bits of the multimedia stream including the at least one pattern;

broadcasting the multimedia stream including the at least one hyperlink, wherein the broadcasted multimedia stream is played on a display device;

receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and

providing another multimedia stream corresponding to at least one of the at least one hyperlink and the broadcasting channel information to the computing device.

In a second aspect, an embodiment of the present disclosure provides a method for providing multimedia content in a network, the method comprising:

receiving a multimedia stream including at least one pattern;

assigning at least one hyperlink to each of time indexed bits of the multimedia stream including the at least one pattern;

analyzing the multimedia stream to recognize a plurality of image patterns and a plurality of text patterns;

tagging the multimedia stream with at least one of one or more pre-stored image patterns and one or more pre-stored text patterns based on the analysis;

broadcasting the multimedia stream including the at least one hyperlink, the one or more pre-stored image patterns and the one or more pre-stored text patterns, wherein the broadcasted multimedia stream is played on a display device;

receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and

providing another multimedia stream corresponding to at least one of the at least one hyperlink and the broadcasting channel information to the computing device.

In a third aspect, an embodiment of the present disclosure provides a system for providing multimedia content in a network, the system comprising:

a server comprising:
a multimedia processor configured to:
   assign at least one hyperlink to each of individual bits of a multimedia stream including at least one pattern;
   analyse the multimedia stream to recognize a plurality of image patterns and a plurality of text patterns; and
   tag the multimedia stream with at least one of one or more pre-stored image patterns and one or more pre-stored text patterns based on the analysis;
a broadcast scheduler configured to broadcast the multimedia stream including the at least one hyperlink, the one or more pre-stored image patterns and the one or more pre-stored text patterns, wherein the broadcasted multimedia stream is played on a display device; and
a transceiver configured to:
   receive the multimedia stream including the at least one pattern;
   receive a multimedia access request including at least one of a captured broadcasted multimedia stream, at least one hyperlink, and a broadcasting channel information from a computing device, wherein the computing device captures a part of the broadcasted multimedia from the display device and identifies the broadcasting channel information based on the at least one pattern in the captured broadcasted multimedia stream; and
   provide another multimedia stream corresponding to at least one of the at least one hyperlink and the broadcasting channel information.

Embodiments of the present disclosure substantially eliminate or at least partially address the aforementioned problems in the prior art, and enables distribution of multimedia content in an efficient manner. The present disclosure further enables associating additional information such as hyperlinks, with user generated or viewer-generated multimedia content.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A-1B are schematic illustrations of a system for providing multimedia content in a network, in accordance with different embodiments of the present disclosure;

FIG. 2 is a schematic illustration of a block diagram of a computing device, in accordance with an embodiment of the present disclosure;

FIG. 3 is a schematic illustration of a block diagram of a server, in accordance with an embodiment of the present disclosure;

FIG. 4 is a schematic illustration of a block diagram of a television (TV) broadcasting system, in accordance with an embodiment of the present disclosure;

FIGS. 5A-5B is a flowchart illustrating steps of a method for providing multimedia content in a network, in accordance with an embodiment of the present disclosure;

FIGS. 6A-6B is a flowchart illustrating steps of a method for providing multimedia content in a network, in accordance with another embodiment of the present disclosure;

FIGS. 7A-7B is a flowchart illustrating steps of a method for analysing a multimedia stream, in accordance with an embodiment of the present disclosure; and

FIG. 8 is a flowchart illustrating steps of a method for processing a broadcast request in a network, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

### GLOSSARY

Brief definitions of terms used throughout the present disclosure are given below.

As used herein, the term “computing device” refers to a device configured to connect to a network such as the Internet and communicate with other devices present in the network. The computing device is also configured to receive data broadcasted by a server or a television broadcasting system via a content delivery network or the Internet®.

As used herein, the term “multimedia stream” refers to a multimedia file including an audio file/stream, a video file/stream, or combination thereof.

Further as used herein, the term “pattern” refers to an invisible and inaudible signal key or any other recognizable pattern ingested into a multimedia stream to identify a broadcasting channel.

Furthermore, as used herein, the term “display device” refers to a device configured to play or display a multimedia content. The display device may be a touch enabled screen.

As used herein, the term “Electronic Programming Guide” (EPG) refers to a broadcasting schedule or electronic guide containing breakdown in individual broadcasts and multimedia content.

As used herein, the term “broadcasting channel” refers to a system which is a combination of hardware, firmware, software, and combination of these and is configured to broadcast multimedia content.

Further, as used herein, the term “television broadcasting system” or “TV broadcasting system” refers to a system operable to ingest at least one pattern into a multimedia stream.

Further as used herein, the term “Television broadcast” or “TV broadcast” is being used to refer to a multimedia content being broadcasted by a TV broadcasting system.

Further, as used herein, the term “Television programming” or “TV programming” refers to a multimedia content being broadcasted for viewing on a TV or any suitable display device.

Further, “as used herein the term “Linear Television” or “Linear TV” refers to a mix of live or pre-recorded content with a pre-determined broadcasting schedule usually put together in a playlist by the broadcaster.

Furthermore, as used herein, the term “broadcast request” refers to a request for scheduling broadcast of one or more user generated multimedia content and/or a number of audio/video streams.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based upon the present disclosure provided herein, one of ordinary skill in the art will appreciate a variety of ways in which connection or coupling exists in accordance with the aforementioned definition.

The terms “first”, “second”, and the like, herein do not denote any order, quantity, or importance, but rather are used to distinguish one element from another. Furthermore, the terms “a” and “an” herein do not denote a limitation of quantity, but rather denote the presence of at least one of the referenced item.

The phrases “in an embodiment”, “in accordance with an embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic; thus, the component or feature is to be regarded as being optional, in such case.

### EMBODIMENTS OF THE PRESENT DISCLOSURE

In a first aspect, an embodiment of the present disclosure provides a method for providing multimedia stream including at least one pattern, the method comprising:

receiving a multimedia stream including at least one pattern;

assigning at least one hyperlink to each of time indexed bits of the multimedia stream including the at least one pattern;

broadcasting the multimedia stream including the at least one hyperlink, wherein the broadcasted multimedia stream is played on a display device;

receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and

providing another multimedia stream corresponding to at least one of the at least one hyperlink and the broadcasting channel information to the computing device.

In a second aspect, an embodiment of the present disclosure provides a method for providing multimedia content in a network, the method comprising:

receiving a multimedia stream including at least one pattern;

assigning at least one hyperlink to each of time indexed bits of the multimedia stream including the at least one pattern;

analyzing the multimedia stream to recognize a plurality of image patterns and a plurality of text patterns;

tagging the multimedia stream with at least one of one or more pre-stored image patterns and one or more pre-stored text patterns based on the analysis;

broadcasting the multimedia stream including the at least one hyperlink, the one or more pre-stored image patterns and the one or more pre-stored text patterns, wherein the broadcasted multimedia stream is played on a display device;

receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and

providing another multimedia stream corresponding to at least one of the at least one hyperlink and the broadcasting channel information to the computing device.

In a third aspect, an embodiment of the present disclosure provides a system for providing multimedia content in a network, the system comprising:

a server comprising:
a multimedia processor configured to:
assign at least one hyperlink to each of individual bits of a multimedia stream including at least one pattern;
analyse the multimedia stream to recognize a plurality of image patterns and a plurality of text patterns; and
tag the multimedia stream with at least one of one or more pre-stored image patterns and one or more pre-stored text patterns based on the analysis;

a broadcast scheduler configured to broadcast the multimedia stream including the at least one hyperlink, the one or more pre-stored image patterns and the one or more pre-stored text patterns, wherein the broadcasted multimedia stream is played on a display device; and

a transceiver configured to:
receive the multimedia stream including the at least one pattern;
receive a multimedia access request including at least one of a captured broadcasted multimedia stream, at least one hyperlink, and a broadcasting channel information from a computing device, wherein the computing device captures a part of the broadcasted multimedia from the display device and identifies the broadcasting channel information based on the at least one pattern in the captured broadcasted multimedia stream; and
provide another multimedia stream corresponding to at least one of the at least one hyperlink and the broadcasting channel information.

The system is configured to provide multimedia content in a network. The system includes a server. In an embodiment, the system also includes a number of computing devices associated with a number of viewers, a television broadcasting system, a content delivery network, server, and the network.

The server includes a multimedia processor, a broadcast scheduler, a transceiver, first computing device comprises a first camera. In one embodiment, the server includes additional modules, such as, an encoder, and a storage module, and so forth.

The multimedia processor may include a hardware, software, firmware or combination thereof. The multimedia processor is configured to assign at least one hyperlink to each of individual bits of a multimedia stream including at least one pattern. For example, the multimedia processor assigns links to the broadcast's playlist or to individual bits or streams of content which may be time indexed. The at least one pattern includes at least one of a visual pattern overlaid over a visual image such as a logo artwork, a subtle and invisible amplitude modulation of a colour signal, a subtle and inaudible modulation of the audio signal, a sublimal additional signal below a hearing threshold, or combination of these. The hyperlink may include a web address, a URL, and so forth. For example, a URL corresponding to a music video or a TV program. In an exemplary scenario, when a broadcaster of the multimedia stream wants to associate or transmit for example, a web address or a URL along with the specific type of media content, such as a link to a music video or to a TV show, then the multimedia processor may embed the link in the multimedia stream.

The multimedia processor is further configured to analyse the multimedia stream to recognize a plurality of image patterns and a plurality of text patterns. The text patterns and the image patterns may include a number of keywords and/or hashtags. In one embodiment, the multimedia processor is further configured to divide the multimedia stream into a video stream and an audio stream. The multimedia processor may divide the multimedia stream into more than one video streams and audio streams. Further, the multimedia stream may be configured to compare a number of image patterns that are recognized in the video stream with a number of pre-stored image patterns (also referred as reference image patterns) to identify the one or more pre-stored image patterns. Furthermore, the multimedia stream may be configured to convert the audio stream into text information. Further, the multimedia stream may be configured to compare the plurality of text patterns recognized in the text information with a plurality of pre-stored text patterns to identify the one or more pre-stored text patterns, the one or more pre-stored text patterns are sorted based on their frequency of appearance in the text information. The text patterns may include one or more keywords. The pre-stored image patterns and the pre-stored text patterns are the reference image patterns and reference text patterns stored in the storage module of the server. The multimedia processor is furthermore configured to tag the multimedia stream with at least one of one or more pre-stored image patterns and one or more pre-stored text patterns (or keywords) based on the analysis. The multimedia processor may be configured to tag the multimedia stream with the one or more keywords and/or store the tagged multimedia stream in the storage module of the server or the content delivery network.

In one embodiment, the multimedia stream along with the one or more pre-stored image patterns and the one or more pre-stored text patterns are stored in the storage module of the server. In an alternative embodiment, the multimedia stream along with the one or more pre-stored image patterns and the one or more pre-stored text patterns are stored in a content delivery network.

In an embodiment, the multimedia processor is further configured to store the one or more pre-stored image patterns and the one or more pre-stored text patterns along with the multimedia stream in a content delivery network (CDN) for on-demand viewing by one or more viewers. A viewer can search a multimedia stream based on one or more keywords and download or view online from the CDN at a time of his/her convenience.

In an exemplary scenario, a recorded live or stored media file is split into its video and audio information. The file may typically include descriptive information and a title. Then, the server (or the multimedia processor) may employ image and pattern recognition algorithms to find relevant patterns or structures within the video file, e.g. certain brands or logos. The multimedia processor then may compare the found patterns with reference patterns or reference information stored in the storage module of the server. Thereafter, audio speech to text algorithms may be employed by the multimedia processor for converting the voice over of the media file into text information. The text information then may be scanned by the multimedia processor for identifying reference keywords. The keywords may be sorted by frequency of appearance. The descriptive text and title of the media file may also be scanned for identifying reference keywords. The combined reference keywords and reference patterns may be used for tagging the media file. The media file and the tags then may be stored or uploaded to video platforms, such as online video viewing websites, for on-demand viewing.

The broadcast scheduler of the server is configured to broadcast the multimedia stream including the at least one hyperlink, the one or more pre-stored image patterns and the one or more pre-stored text patterns. The broadcasted multimedia stream may be played on a display device. Examples of the display device may include, but are not limited to, a television, a mobile phone, a projector screen, a tablet computer, a computer, a laptop, and so forth. The broadcast scheduler may include hardware, software, firmware, and combination thereof.

In one embodiment, the broadcast scheduler is configured to propose one or more time slots for broadcasting the plurality of audio/video streams to a viewer associated with the computing device from which the audio/video streams are received. The time slots may include a particular time duration and a time in which the audio/video streams can be broadcasted. For example, the time slots may be 8 AM, 9 PM, 2 PM, on June 30th or on every Sunday of every month. The viewer may select at least one of the one or more time slots in which the audio/video streams can be played by the server. Further, the broadcast scheduler may be configured to assemble the received plurality of audio/video streams to construct at least one linear broadcasting schedule. In one embodiment, the broadcast scheduler is configured to assemble the received audio/video streams to construct at least one EPG. The EPG is an electronic programming guide including a breakdown of individual broadcasts or programs scheduled to be broadcasted. Furthermore, the broadcast scheduler may be configured to broadcast the received audio/video streams according to the at least one linear broadcasting schedule (For example, an EPG).

In an embodiment, the broadcast scheduler is also configured to upload the multimedia streams received from the computing device onto a content delivery network (CDN) immediately and store the multimedia streams for later broadcast or download or viewing by a viewer. In one embodiment, the broadcast scheduler is configured to broadcast a pre-recorded multimedia stream when the broadcasting of one or more of the audio/video streams fails. The pre-recorded multimedia stream may include a pre-recorded announcement, another pre-recorded audio/video stream, and so forth.

The transceiver of the server is configured to receive the multimedia stream including the at least one pattern. The at least one pattern may uniquely identify a broadcast channel associated with the multimedia stream. Further, the at least one pattern may be an invisible and inaudible signal key or any other recognizable pattern that can be ingested into the multimedia stream for identifying the broadcasting channel, a broadcaster, or information of a broadcasting channel. The transceiver of the server is configured to receive a multimedia access request including at least one of a captured broadcasted multimedia stream, at least one hyperlink, and a broadcasting channel information from a computing device, wherein the computing device captures a part of the broadcasted multimedia from the display device and identifies the broadcasting channel information based on the at least one pattern in the captured broadcasted multimedia stream. The transceiver of the server is further configured to provide another multimedia stream corresponding to at least one of the at least one hyperlink and the broadcasting channel information.

In one embodiment, the transceiver of the server is further configured to receive a broadcast request including a plurality of audio/video streams and at least one proposed time slots available for the broadcast of the plurality of audio/video streams from the computing device. The audio/video streams include at least one of a live audio/video stream, a pre-recorded live-on-tape audio/video stream, and a pre-recorded live-on-tape audio/video stream comprising an overlaid live element.

In one embodiment, the encoder of the server is configured to encrypt or encode the multimedia streams before transmitting to other devices or storing in the storage module of the server. The encoder may encode the multimedia stream(s) using a suitable codec, for example, H.264 or MPEG, and so forth.

Further, the storage module of the server is configured to store the multimedia content, the broadcasting channel information, the pre-stored image patterns, the prestored text patterns, the at least one pattern, information about the multimedia stream and various broadcasters operable to broadcast multimedia content in the network, and so forth. The storage module of the server may also be configured to store and maintain a detailed list of individual broadcasting channels' information and multimedia stream elements that each of which contains an exact time of broadcast and the desired hyperlink or URL or web address that may lead to another multimedia stream. The storage module of the server is also configured to store a plurality of patterns and their corresponding broadcasting channel information. The storage module may be configured to store details about TV programming or programs to be broadcasted on the computing devices or one or more display devices through the network, such as the Internet®, a TV broadcasting system, or CDN. In one embodiment, the storage module of the server is configured to store electronic programming guides of linear TV created using user-generated content, live content, pre-recorded live-on-tape audio/video stream including an overlaid live element.

In an exemplary scenario, the server is configured to receive one or more chunks of a pre-determined length for example, 4 minutes of audio/video stream or a pre-recorded live on tape content at a preset time from a computing device. Further, the chinks may include at least one pattern. The broadcast scheduler may be configured to assemble these chunks of video/audio streams and construct a linear broadcasting schedule and create an EPG for the viewers. In one embodiment, the EPG may be created based on W channels, for example, content of one channel under one category in the EPG, type of content for example, sports related under same category in the EPG, and so forth. The broadcasting scheduler may receive these chunks of video/audio streams along with proposed available time slots. In one embodiment, new time slot are proposed to the viewer.

In an embodiment, the computing device is a portable device such as, but not limited to, a smart phone, and a digital camera associated with a viewer. The computing device is capable of connecting with the network and communicate and exchange content with the server. In one embodiment, the computing device is configured to capture images, or audio/video stream from the display device.

Further, the computing device includes a camera, a microphone, a transceiver, a storage module, and a broadcast processing module. An associated viewer of the computing device can use the camera for recording or capturing images or audio/videos In an embodiment, the camera and/or the microphone captures a part of the broadcasted multimedia stream from the display device and identifies the broadcasting channel information based on the at least one pattern in the captured broadcasted multimedia stream. The multimedia stream may include a TV broadcast being displayed on a display device such as a television. The microphone may be used to record audio streams that can be combined with other multimedia content on the computing device. In one embodiment, the camera and/or microphone are integrated within the computing device. In another embodiment, the camera and/or microphone are not integrated within the computing device. The camera and/or the microphone may be hardware and/or software components.

In one embodiment, the transceiver of the computing device is configured to send multimedia streams including captured broadcasted multimedia to the server. The transceiver may be configured to receive multimedia stream or the broadcasted multimedia stream from the TV broadcasting system or the server or the content delivery network (CDN. The transceiver may also be configure to download the multimedia streams from the CDN for viewing on the computing device or on associated display device. In one embodiment, the computing device and more specifically transceiver of the computing device is configured to send a multimedia access request including a captured broadcasted multimedia stream, at least one hyperlink, a broadcasting channel information, and combination thereof. When the viewer selects or clicks on the hyperlink, another multimedia stream may be requested by the transceiver from the server or the CDN. In one embodiment, the computing device is configured to send a multimedia access request to the server.

In one embodiment, the computing device and more specifically the transceiver of the computing device is also configured to send a broadcast request including a number of audio/video streams. The audio/video streams may include at least one of a live audio/video stream, a pre-recorded live-on-tape audio/video stream, and a pre-recorded live-on-tape audio/video stream including an overlaid live element. For example, the viewer may capture a video stream and embed a music or image in the video stream and send it in the broadcast request. The broadcast request may further include at least one proposed time slots available for the broadcast of the audio/video streams. The transceiver is further configured to receive one or more time slots from the server for broadcasting the audio/video streams of the broadcast request. Thereafter, the viewer may select at least one of the one or more time slots.

In one embodiment, the storage module of the computing device is configured to store the multimedia streams, broadcasting channel information, and so forth.

In one embodiment, the broadcasting processing module of the computing device is configured to process the captured part of the broadcasted multimedia stream from the display device. The computing device or more specifically the broadcasting processing module may be configured to identify the broadcasting channel information based on at least one pattern in the captured broadcasted multimedia stream. The broadcasting channel information may include such as, but not limiting to, channel name, channel identifier, channel web address, and so forth.

In one embodiment, the broadcast processing module is configured to broadcast chunks of video/audio streams including pre-recorded content in a network. In another embodiment, the broadcast processing module is configured to upload the chunks of the video/audio streams onto the CDN for automated retrieval by the broadcast scheduler of the server or for later broadcast. For example, the broadcast processing module may analyze a TV image using the camera and/or microphone to identify a broadcasting channel associated with the image, and then the computing device may connect to the server and retrieve the link corresponding to the identified channel and image.

In an exemplary scenario, the viewer may point the computing device towards a display device like TV showing the broadcasted multimedia stream and record a limited time of audio/video stream. This audio/video stream is then searched for the distinctive at least one pattern that has been ingested into the audio/video stream. When the pattern is found, the broadcast processing module unmistakably identifies broadcasting channel information and sends a broadcast request to the server. The server may look up the received audio/video stream fragment that is set to play at the time of the broadcast request and may return an associated web address to the computing device, where the transceiver of the computing device receives the associated web address. The broadcast processing module may be configured to open the received web address, in one embodiment based on one or more input from the viewer.

In one embodiment, the system for providing multimedia content includes a TV broadcasting system including a playlist scheduler, a transceiver, an encoder, a pattern generator, and a storage module. In one embodiment, the television broadcasting system ingests at least one pattern in a multimedia stream. The televisions broadcasting system may be a combination of multiple broadcasting servers configured to encode and broadcast transmission of a number of multimedia streams as per pre-defined schedule on display devices of the viewers.

In one embodiment, the playlist scheduler is configured to create playlists of their TV programming and also to create high level programming schedules base don't the user-generated content or multimedia streams received from the computing device. In one embodiment, the playlist scheduler is configured to create EPG based on the user-generated content, live content, and a pre-recorded live-on-tape audio/video stream including an overlaid live element. The EPG may be created based on the broadcast request(s) received from the computing device(s). The playlist scheduler may include hardware, software, firmware, or combination thereof.

The transceiver of the TV broadcasting system is configured to send and receive multimedia streams and/or the TV programming to the server or to the multiple computing devices. The transceiver is also configured to receive multimedia content from multiple broadcasting channels or individual broadcasting devices (for example, computing device). The received multimedia content may include pre-recorded multimedia streams, live multimedia streams, pre-recorded live-on-tape audio/video stream including an overlaid live element, or combination thereof. Further, the transceiver may include hardware, software, firmware, or combination thereof.

The encoder of the TV broadcasting system is configured to encode the multimedia content including audio/video streams, multimedia streams, and other information stored in the storage module of the TV broadcasting system. The encoder may encode the multimedia stream using a suitable codec, for example, H.264 or MPEG, and so forth. The encoder may include hardware, software, firmware, or combination thereof.

In one embodiment, the pattern generator of the TV broadcasting system is configured to ingest at least one pattern in a number of multimedia streams. The at least one pattern may be an invisible or inaudible pattern that may uniquely identify a broadcasting channel. The pattern generator is also configured to read the ingested at least one pattern in the multimedia stream(s). In one embodiment, the at least one pattern is a visual pattern that may be overlaid over the visible image such as a logo art work. In another embodiment, the at least one pattern is a subtle and invisible amplitude modulation of the colour signal. In another embodiment, the at least one pattern is a subtle and inaudible modulation of the audio signal or an insertion of a subliminal additional signal below the hearing threshold.

In one embodiment, the storage module of the TV broadcasting system is configured to store electronic programming guides of linear TV created using user-generated content, live content, pre-recorded live-on-tape audio/video stream including an overlaid live element. Further, the to store module of the TV broadcasting system may be configured to store a number of patterns and their corresponding broadcasting channel information, details about TV programming or programs to be broadcasted on the computing devices or one or more display devices through the network, such as the Internet® and/or the CDN. The storage module may also be configured to store and maintain a detailed list of individual broadcasting channels' information and multimedia stream elements that each of which contains an exact time of broadcast and the desired hyperlink or URL or web address that may lead to another multimedia stream. The storage module may include hardware, software, firmware, or combination thereof.

In one embodiment, the content delivery network (CDN) is a network of proxy servers globally distributed and deployed in multiple data centers. The CDN may be configured to store the multimedia streams, the plurality of audio/video streams, the tagged multimedia streams, and so forth. The CDN may include one or more multiple hardware, software, firmware components, or combination of these.

In one embodiment, the computing devices, the server, the CDN, and the TV broadcasting system is configured to exchange or share multimedia content via a network. According to an embodiment, the network can be a single network or a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet®, second generation (2G) telecommunication networks, third generation (3G) telecommunication networks, fourth generation (4G) telecommunication networks, and Worldwide Interoperability for Microwave Access (WiMAX) networks.

The present disclosure provides method and systems for providing multimedia content in a network.

The present disclosure further provides methods and systems for creating linear television (TV) channels from mixed user generated pre-recorded live and live-over content elements (or multimedia content) that are assembled and managed by a server.

The present disclosure also provides methods and systems for tagging the pre-recorded or live multimedia content with multiple text patterns (or keywords) and using the same for on-demand viewing.

The methods and systems described in the present disclosure overcome the drawbacks associated with conventional techniques by enabling automated tagging of digital audio/visual streams (of multimedia content) to improve advertising relevance for advertisements placed around this multimedia content and facilitate better content search. The disclosed methods and systems employs image pattern recognition and audio to text algorithms to create a keyword list by separately analyzing the video and audio streams of a multimedia stream. The keywords, then ay be used for tagging the multimedia stream before storing it for on-demand viewing and searching on the CDN.

Advantageously, the disclosed methods and systems enables the viewers to propose one or more time slots for publishing multimedia content generated by the viewer via the TV broadcasting system.

Further, the disclosed methods and systems enables creation of linear TV using the user-generated content including pre-recorded content, live content, live-over content, and so forth.

### DETAILED DESCRIPTION OF THE DRAWINGS

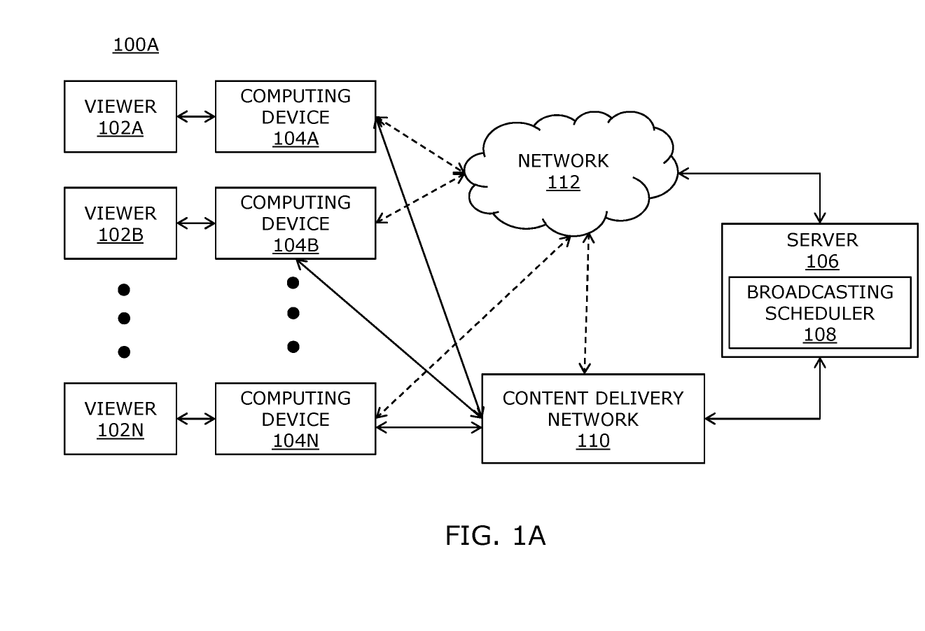

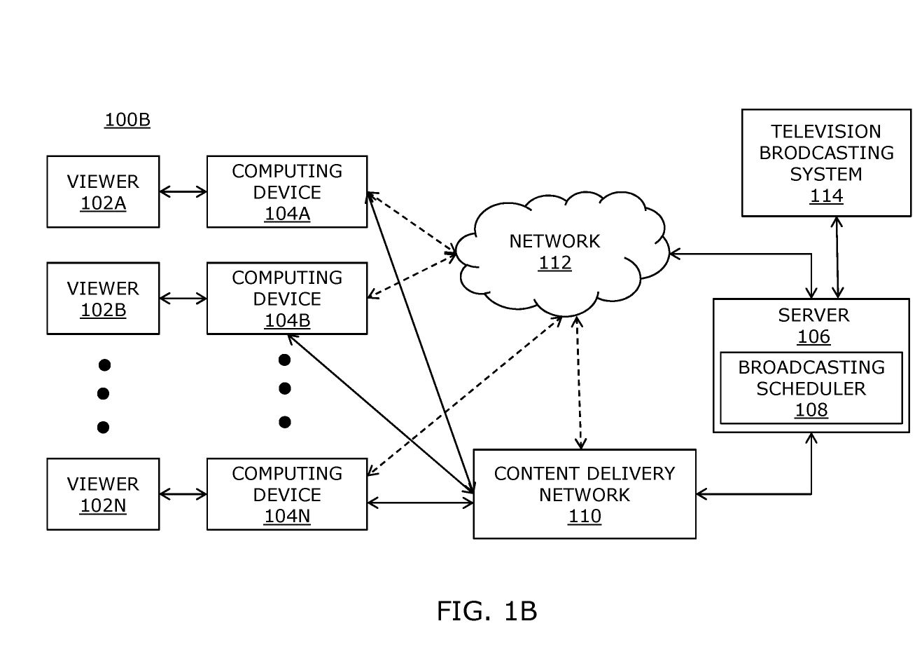

Referring to FIG. 1A, illustrated is a system 100A for providing multimedia content in a network, in accordance with a first embodiment of the present disclosure. As shown, the system 100A includes a multiple viewers 102A-102N, a number of associated computing devices 104A-104N, a server 106, and a content delivery network (CDN) 110. The computing devices 104A-104N, the server 106, the content delivery network (CDN) 110 may be configured to connect to a network 112 for sharing and exchanging data.

Referring now to FIG. 1B, illustrated is a system for providing multimedia content in a network, in accordance with another embodiment of the present disclosure. As shown, the system 100B includes the viewers 102A-102N, their associated computing devices 104A-104N, the server 106, the content delivery network (CDN) 110, and a television (TV) broadcasting system 114. The computing devices 104A-104N, the server 106, the content delivery network (CDN) 110 may be configured to connect to the network 112 for sharing and exchanging data.

The server 106 further includes a broadcast scheduler 108. The server 106 is configured to receive a multimedia stream including at least one pattern from a computing device and assign at least one hyperlink to each of time indexed bits of the multimedia stream including the at least one pattern. The broadcast scheduler 108 is configured to broadcast the multimedia stream including the at least one hyperlink, wherein the broadcasted multimedia stream is played on a display device such as a TV or smart phone. The server 106 is also configured to receive a multimedia access request including at least one of a captured broadcasted multimedia stream, at least one hyperlink and a broadcasting channel information from a computing device such as the computing device 104A. The broadcast scheduler 108 is configured to provide another multimedia stream corresponding to at least one of the at least one hyperlink and the broadcasting channel information to the computing device.

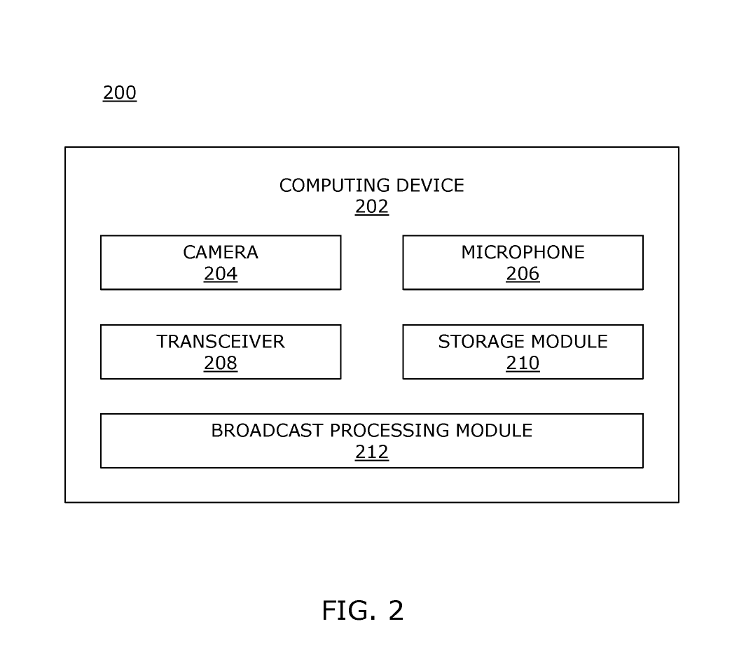

FIG. 2 is a schematic illustration of a block diagram 200 of a computing device 202, in accordance with an embodiment of the present disclosure. As shown, the computing device 202 includes a camera 204, a microphone 206, a transceiver 208, a storage module 210, and a broadcast processing module 212.

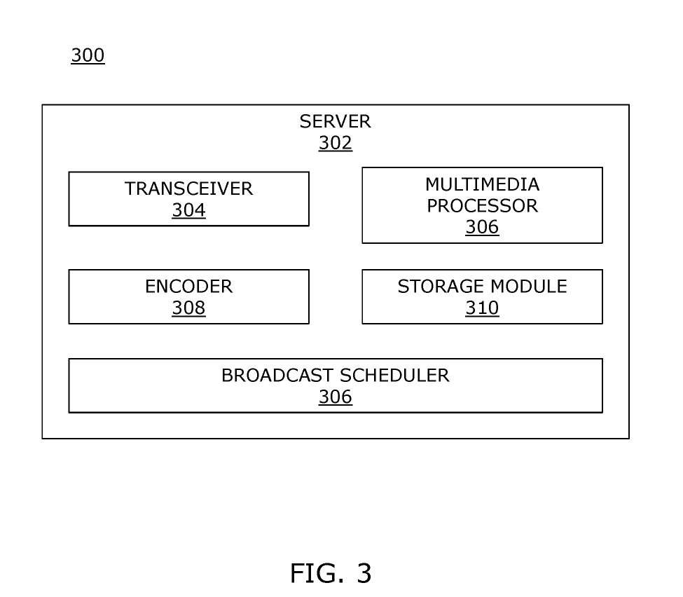

FIG. 3 is a schematic illustration of a block diagram 300 of a server 302, in accordance with an embodiment of the present disclosure. The server 302 includes a transceiver 304, a multimedia processor 306, an encoder 308, a storage module 310, and a broadcast scheduler 312. The broadcast scheduler 312 broadcast the multimedia stream including the at least one hyperlink, the one or more pre-stored image patterns and the one or more pre-stored text patterns. The broadcasted multimedia stream is played on a display device such as a television, a tablet computer, and so forth.

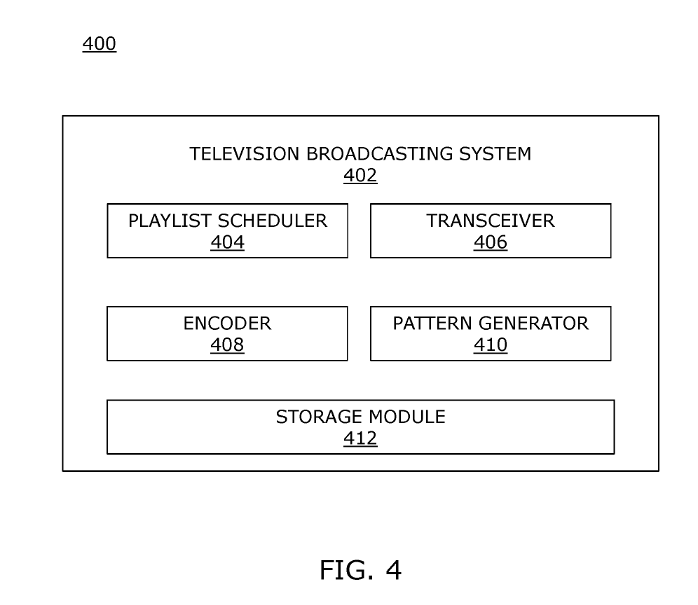

FIG. 4 is a schematic illustration of a block diagram 400 of a television (TV) broadcasting system 402, in accordance with an embodiment of the present disclosure. As shown, the TV broadcasting system 402 includes a playlist scheduler 404, a transceiver 406, an encoder 408, a pattern generator 410, and a storage module 412. The pattern generator 410 is configured to ingest at least one pattern into a multimedia stream.

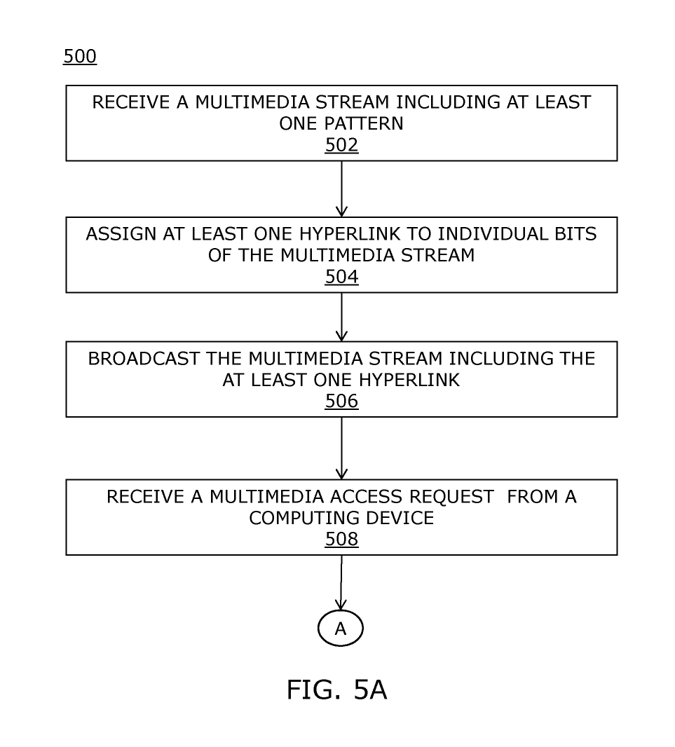

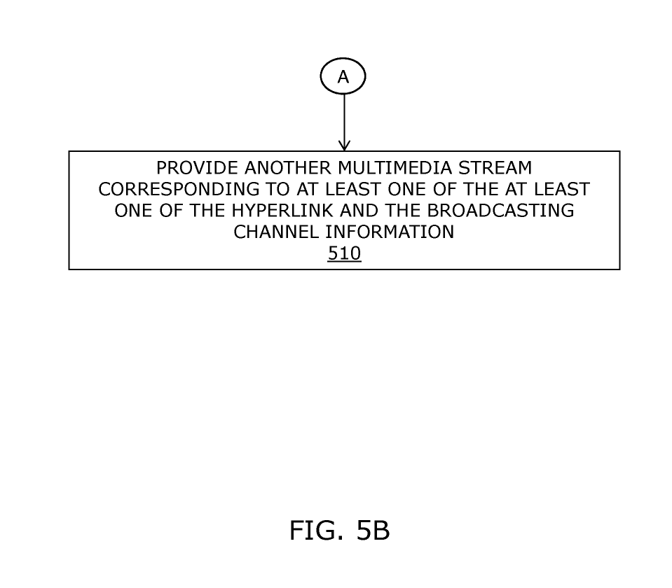

FIGS. 5A-5B is a flowchart illustrating steps of a method 500 for providing multimedia content in a network, in accordance with an embodiment of the present disclosure. At step 502, a multimedia stream is received. In an embodiment, the server receives the multimedia stream from a computing device (such as the computing device 104A). Then at step 504, the server assigns at least one hyperlink to each of time indexed bits of the multimedia stream including the at least one pattern. Then at step 506, the multimedia stream including the at least one hyperlink is broadcasted. The server broadcasts the multimedia stream including the at least one hyperlink. The broadcasted multimedia stream may be viewed by a viewer on the computing device or the display device.

At step 508, the server receives a multimedia access request from the computing device. The multimedia access request may include at least one of a captured broadcasted multimedia stream, at least one hyperlink and a broadcasting channel information from the computing device. Thereafter, at step 510, the server provides another multimedia stream corresponding to at least one of the at least one hyperlink and the broadcasting channel information to the computing device.

The steps 502 to 510 are only illustrative and other alternatives can also be provided where one or more steps are added, one or more steps are removed, or one or more steps are provided in a different sequence without departing from the scope of the claims herein.

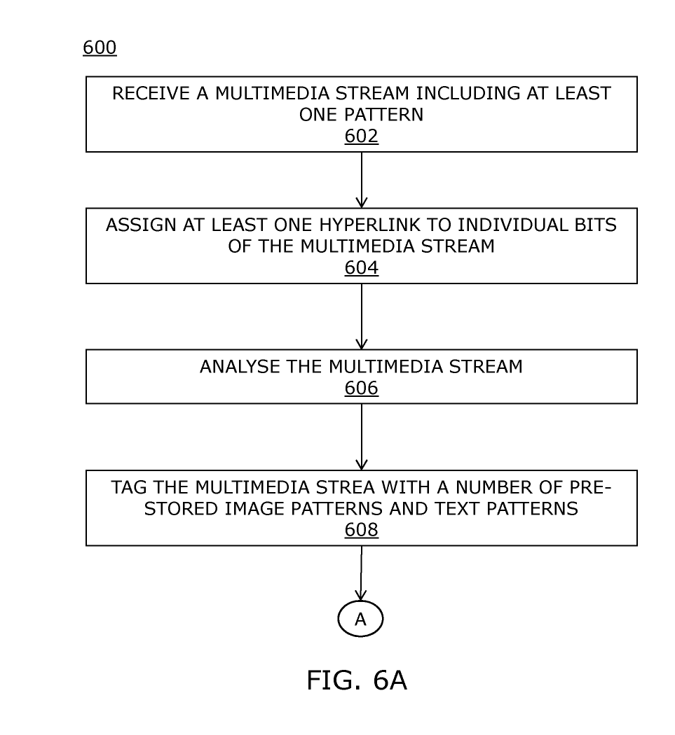

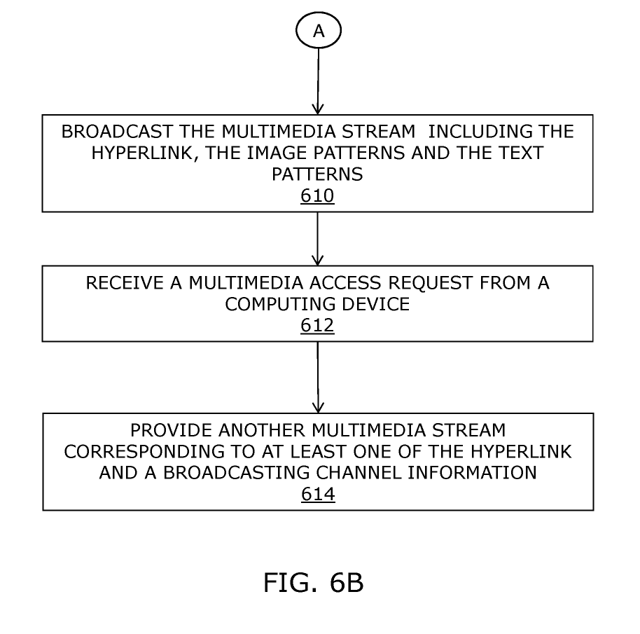

FIGS. 6A-6B is a flowchart illustrating steps of a method 600 for providing multimedia content in a network, in accordance with another embodiment of the present disclosure. The method 600 initiates at step 602. At step 602, a server receives a multimedia stream from a computing device. The multimedia stream includes at least one pattern. Then at step 604, the server assigns at least one hyperlink to each of time indexed bits of the multimedia stream including the at least one pattern. At step 606, the multimedia stream is analysed to recognize a number of image patterns and a number of text patterns. The text patterns may be keywords. Then at step 608, the multimedia stream is tagged with at least one of one or more pre-stored image patterns and one or more pre-stored text patterns based on the analysis.

Thereafter, at step 610, the server broadcasts the multimedia stream including the at least one hyperlink, the one or more pre-stored image patterns and the one or more pre-stored text patterns. The multimedia stream may be broadcasted by a server and may be played on a display device. Then at step 612, the server receives a multimedia access request including at least one of a captured broadcasted multimedia stream, at least one hyperlink and a broadcasting channel information from a computing device. At step 614, another multimedia stream corresponding to at least one of the at least one hyperlink and the broadcasting channel information is provided to the computing device.

The steps 602 to 614 are only illustrative and other alternatives can also be provided where one or more steps are added, one or more steps are removed, or one or more steps are provided in a different sequence without departing from the scope of the claims herein.

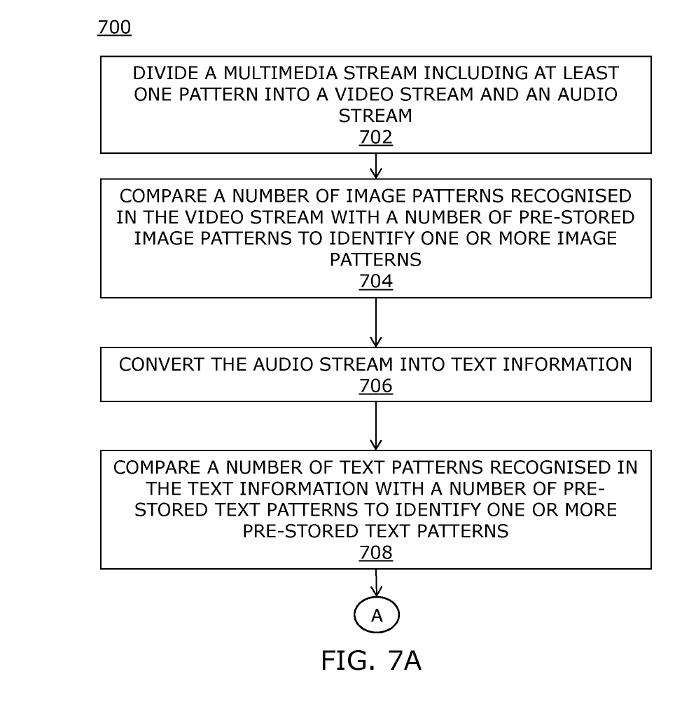

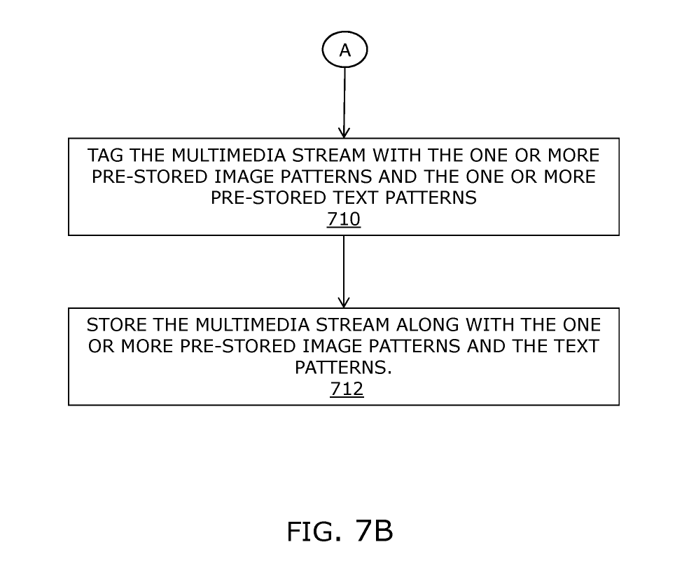

FIGS. 7A-7B is a flowchart illustrating steps of a method for analysing a multimedia stream, in accordance with an embodiment of the present disclosure. As discussed with reference to FIG. 5, a multimedia stream including at least one pattern is received from a computing device. The server is configured to analyse the multimedia stream. At step 702, the multimedia stream is divided into a video stream and an audio stream. In one embodiment, the multimedia stream may be divided into multiple audio streams and multiple video streams. Then at step 704, a number of image patterns recognised in the video stream are compared with a number of pre-stored image patterns to identify one or more pre-stored image patterns. Then at step 706, the audio stream is converted into text information. At step 708, a plurality of text patterns (or keywords) that are recognized in the text information are compared with a plurality of pre-stored text patterns to identify one or more pre-stored text patterns (or keywords). The one or more text patterns may be sorted based on their frequency of appearance in the text information.

Then at step 710, the multimedia stream is tagged with at least one of the one or more pre-stored image patterns and the one or more pre-stored text patterns. Thereafter, at step 712, the one or more pre-stored image patterns and the one or more pre-stored text patterns along with the multimedia stream are stored.

The steps 702 to 712 are only illustrative and other alternatives can also be provided where one or more steps are added, one or more steps are removed, or one or more steps are provided in a different sequence without departing from the scope of the claims herein.

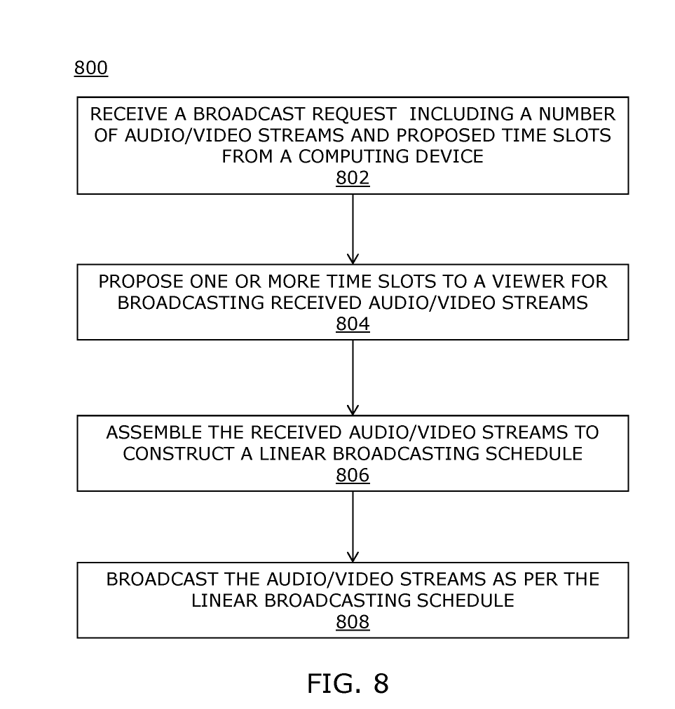

FIG. 8 is a flowchart illustrating steps of a method 800 for processing a broadcast request in a network, in accordance with another embodiment of the present disclosure. As discussed with reference to FIGS. 1A-1B, a computing device is configured to send a broadcast request to a server.

At step 802, the server receives a broadcast request including at least one of a number of audio/video streams and at least one proposed time slot available for the broadcast of the audio/video streams from the computing device. The audio/video streams includes at least one of a live audio/video stream, a pre-recorded (or user-generated) live-on-tape audio/video stream, and a pre-recorded live-on-tape audio/video stream comprising an overlaid live element.

At step 804, the server proposes one or more time slots for broadcasting the audio/video streams to a viewer associated with the computing device. The viewer may select at least one of the one or more time slots.

Then at step 806, the server assembles received audio/video streams to construct at least one linear broadcasting schedule. At step 810, the server broadcasts received audio/video streams according to the at least one linear broadcasting schedule.

The steps 802 to 810 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for providing multimedia content in a network, the method comprising:
receiving a multimedia stream including at least one pattern;
assigning at least one hyperlink to each of time indexed bits of the multimedia stream including the at least one pattern;
broadcasting the multimedia stream including the at least one hyperlink, wherein the broadcasted multimedia stream is played on a display device;
receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and
providing another multimedia stream corresponding to at least one of the at least one hyperlink and the broadcasting channel information to the computing device.

2. A method of claim 1, wherein a television broadcasting system ingests the at least one pattern in to the multimedia stream, wherein the at least one pattern comprises at least one of a visual pattern overlaid over a visual image, a subtle and invisible amplitude modulation of a colour signal, a subtle and inaudible modulation of the audio signal, a subliminal additional signal below a hearing threshold.

3. The method of claim 1 further comprising analysing the multimedia stream further comprises:
dividing the multimedia stream into a video stream and an audio stream;
comparing a plurality of image patterns recognized in the video stream with a plurality of pre-stored image patterns to identify one or more pre-stored image patterns;
converting the audio stream into text information;
comparing a plurality of text patterns recognized in the text information with a plurality of pre-stored text patterns to identify one or more pre-stored text patterns, the one or more pre-stored text patterns are sorted based on their frequency of appearance in the text information;
tagging the multimedia stream with at least one of the one or more pre-stored image patterns and the one or more pre-stored text patterns based on the analysis; and
storing the one or more pre-stored image patterns and the one or more pre-stored text patterns along with the multimedia stream.

4. The method of claim 3 further comprising storing the one or more pre-stored image patterns and the one or more pre-stored text patterns along with the multimedia stream in a content delivery network for on-demand viewing by one or more viewers.

5. The method of claim 4 further comprising:
receiving a broadcast request including a plurality of audio/video streams from the computing device, wherein the plurality of audio/video streams comprises at least one of a live audio/video stream, a pre-recorded live-on-tape audio/video stream, and a pre-recorded live-on-tape audio/video stream comprising an overlaid live element;
assembling the received plurality of audio/video streams to construct at least one linear broadcasting schedule; and
broadcasting the received plurality of audio/video streams according to the at least one linear broadcasting schedule.

6. The method of claim 5, wherein the broadcast request further comprises at least one proposed time slots available for the broadcast of the plurality of audio/video streams.

7. The method of claim 5 further comprising broadcasting a pre-recorded multimedia stream when the broadcasting of one or more of the plurality of audio/video streams fails.

8. The method of claim 5 further comprising proposing one or more time slots to a viewer associated with the computing device for broadcasting the plurality of audio/video streams, wherein the viewer selects at least one of the one or more time slots.

9. The method of claim 5, wherein the plurality of audio/video streams are pre-recorded and temporarily stored in the content delivery network for broadcasting in a future time slot.

10. A method for providing multimedia content in a network, the method comprising:
receiving a multimedia stream including at least one pattern;
assigning at least one hyperlink to each of time indexed bits of the multimedia stream including the at least one pattern;
analyzing the multimedia stream to recognize a plurality of image patterns and a plurality of text patterns;
tagging the multimedia stream with at least one of one or more pre-stored image patterns and one or more pre-stored text patterns based on the analysis;
broadcasting the multimedia stream including the at least one hyperlink, the one or more pre-stored image patterns and the one or more pre-stored text patterns, wherein the broadcasted multimedia stream is played on a display device;
receiving a multimedia access request including at least one of a captured broadcasted multimedia stream, at least one hyperlink and a broadcasting channel information from a computing device, wherein the computing device captures a part of the broadcasted multimedia stream from the display device and identifies the broadcasting channel information based on the at least one pattern in the captured broadcasted multimedia stream; and
providing another multimedia stream corresponding to at least one of the at least one hyperlink and the broadcasting channel information to the computing device.

11. A method of claim 10, wherein a television broadcasting system ingests the at least one pattern in to the multimedia stream, wherein the at least one pattern comprises at least one of a visual pattern overlaid over a visual image, a subtle and invisible amplitude modulation of a colour signal, a subtle and inaudible modulation of the audio signal, a subliminal additional signal below a hearing threshold.

12. The method of claim 10, wherein analysing the multimedia stream further comprises:
dividing the multimedia stream into a video stream and an audio stream;
comparing the plurality of image patterns recognized in the video stream with a plurality of pre-stored image patterns to identify the one or more pre-stored image patterns;
converting the audio stream into text information;
comparing the plurality of text patterns recognized in the text information with a plurality of pre-stored text patterns to identify the one or more pre-stored text patterns, the one or more pre-stored text patterns are sorted based on their frequency of appearance in the text information; and
storing the one or more pre-stored image patterns and the one or more pre-stored text patterns along with the multimedia stream.

13. The method of claim 12 further comprising storing the one or more pre-stored image patterns and the one or more pre-stored text patterns along with the multimedia stream in a content delivery network for on-demand viewing by one or more viewer.

14. The method of claim 13 further comprising:
receiving a broadcast request including at least one of a plurality of audio/video streams and at least one proposed time slot available for the broadcast of the plurality of audio/video streams from the computing device, wherein the plurality of audio/video streams comprises at least one of a live audio/video stream, a pre-recorded live-on-tape audio/video stream, and a pre-recorded live-on-tape audio/video stream comprising an overlaid live element;
proposing one or more time slots to a viewer associated with the computing device for broadcasting the plurality of audio/video streams, wherein the viewer selects at least one of the one or more time slots;
assembling the received plurality of audio/video streams to construct at least one linear broadcasting schedule; and
broadcasting the received plurality of audio/video streams according to the at least one linear broadcasting schedule.

15. A system for providing multimedia content in a network, the system comprising:
a server comprising:
a multimedia processor configured to:
assign at least one hyperlink to each of individual bits of a multimedia stream including at least one pattern;
analyse the multimedia stream to recognize a plurality of image patterns and a plurality of text patterns; and
tag the multimedia stream with at least one of one or more pre-stored image patterns and one or more pre-stored text patterns based on the analysis;
a broadcast scheduler configured to broadcast the multimedia stream including the at least one hyperlink, the one or more pre-stored image patterns and the one or more pre-stored text patterns, wherein the broadcasted multimedia stream is played on a display device; and
a transceiver configured to:
receive the multimedia stream including the at least one pattern;
receive a multimedia access request including at least one of a captured broadcasted multimedia stream, at least one hyperlink, and a broadcasting channel information from a computing device, wherein the computing device captures a part of the broadcasted multimedia from the display device and identifies the broadcasting channel information based on the at least one pattern in the captured broadcasted multimedia stream; and
provide another multimedia stream corresponding to at least one of the at least one hyperlink and the broadcasting channel information.

16. The system of claim 15, wherein the multimedia processor is further configured to:
divide the multimedia stream into a video stream and an audio stream;
compare the plurality of image patterns recognized in the video stream with a plurality of pre-stored image patterns to identify the one or more pre-stored image patterns;
convert the audio stream into text information;
compare the plurality of text patterns recognized in the text information with a plurality of pre-stored text patterns to identify the one or more pre-stored text patterns, the one or more pre-stored text patterns are sorted based on their frequency of appearance in the text information; and
store the one or more pre-stored image patterns and the one or more pre-stored text patterns along with the multimedia stream.

17. The system of claim 16, wherein the multimedia processor is further configured to store the one or more pre-stored image patterns and the one or more pre-stored text patterns along with the multimedia stream in a content delivery network for on-demand viewing by one or more viewers.

18. The system of claim 16, wherein:
the transceiver is further configured to receive a broadcast request including a plurality of audio/video streams and at least one proposed time slots available for the broadcast of the plurality of audio/video streams from the computing device, wherein the plurality of audio/video streams comprises at least one of a live audio/video stream, a pre-recorded live-on-tape audio/video stream, and a pre-recorded live-on-tape audio/video stream comprising an overlaid live element; and
the broadcast scheduler is further configured to:
propose one or more time slots for broadcasting the plurality of audio/video streams to a viewer associated with the computing device, wherein the viewer selects at least one of the one or more time slots;
assemble the received plurality of audio/video streams to construct at least one linear broadcasting schedule; and
broadcast the received plurality of audio/video streams according to the at least one linear broadcasting schedule.

19. The system of claim 18, wherein the broadcast scheduler is further configured to broadcast a pre-recorded multimedia stream when the broadcasting of one or more of the plurality of audio/video streams fails.
